(19) United States
(12) Patent Application Publication
(10) Pub. No.: US 2016/0214860 A1
(43) Pub. Date: Jul. 28, 2016

(54) METHOD OF SYNTHESIS OF UNSOLVATED MIXED CATION BOROHYDRIDES

(71) Applicants: Tomasz JAROÑ, Ryki (PL); Wojciech WEGNER, Szczecin (PL); Wojciech GROCHALA, Warszawa (PL)

(72) Inventors: TOMASZ JARON, RYKI (PL); WOJCIECH WEGNER, SZCZECIN (PL); WOJCIECH GROCHALA, WARSZAWA (PL)

(21) Appl. No.: 15/023,507

(22) PCT Filed: Sep. 18, 2014
(86) PCT No.: PCT/IB2014/001884

§ 371 Date: Mar. 21, 2016

(30) Foreign Application Priority Data
Sep. 19, 2013 (PL) 405397

(51) Int. Cl. C01B 6/24

(52) U.S. Cl. CPC C01B 6/246

(57) ABSTRACT

The present invention relates to a novel method of synthesis of unsolvated mixed cation borohydrides of a general formula MₓM′_{y}(BH₄)_{z}, where M and M′ stand for metal cations, x, y, and z are stoichiometric coefficients. The method of synthesis according to the present invention is characterised in that the precursors having a general formula M[Aₙ]ᵤ and [Cat]ᵥM′(BH₄)_{w} are used for the synthesis, where [An] stands for a weakly coordinating anion; [Cat] stands for weakly coordinating cation; u, v, and w are the stoichiometric coefficients; and the synthesis is carried out under an inert to the reagents atmosphere—according to the general reaction equation: x M[An]ᵤ+y [Cat]ᵥ M′(BH₄)_{w}→MₓM′_{y}(BH₄)_{z}+xu [Cat][An] where z=yw, xu=yv; MₓM′_{y}(BH₄)_{z} is the product of the reaction.

### FIELD OF THE INVENTION

The present invention relates to novel method of synthesis of mixed cation borohydrides of general formula MₓM′_{y}(BH₄)_{z}, where M denotes a metal cation, preferably: Li⁺, Na⁺, K⁺, Rb⁺, Cs⁺, Be²⁺, Mg²⁺, Ca²⁺, Sr²⁺, Ba²⁺, Al³⁺, Ga³⁺, Y³⁺, La³⁺, Ce³⁺, Pr³⁺, Nd³⁺, Sm³⁺, Eu²⁺, Eu³⁺, Gd³⁺, Tb³⁺, Dy³⁺, Ho³⁺, Er³⁺, Tm³⁺, Yb²⁺, Yb³⁺, Lu³⁺, Cu⁺, Ag⁺ or a complex cation, like NH₄⁺, while M′ denotes a metal cation, preferably: Be²⁺, Mg²⁺, Ca²⁺, Sr²⁺, Ba²⁺, Al³⁺, Ga³⁺, Se⁺, Y³⁺, La³⁺, Ce³⁺, Pr³⁺, Nd³⁺, Sm³⁺, Eu²⁺, Eu³⁺, Gd³⁺, Tb³⁺, Dy³⁺, Ho³⁺, Er³⁺, Tm³⁺, Yb²⁺, Yb³⁺, Lu³⁺, Ti³⁺, V²⁺, V³⁺, Mn²⁺, Fe³⁺, Co²⁺, Ni²⁺, Cu⁺, Zn²⁺, Cd²⁺, and x, y, z denote stoichiometric coefficients.

### BACKGROUND OF THE INVENTION

Borohydrides, including mixed cation borohydrides, contain significant amount of hydrogen and can be used as hydrogen storage materials e.g. in electric vehicles utilising hydrogen fuel cells (cf. W. Grochala, P. P. Edwards, Chemical Reviews, 104 (2004) 1283-1315). One of the advantages of mixed cation borohydrides is a possibility of control of the process of hydrogen release from these compounds via control of their chemical composition, e.g. in case of hydrogen released thermally it is possible to adjust the thermal stability of mixed cation borohydride. Mixed cation borohydrides composed of light elements show also larger gravimetric hydrogen content than many single cation borohydrides, i.e. heavier elements can be diluted by the use of lighter ones.

Some of mixed cation borohydrides can be used as a source of diborane, B₂H₆, which could be conveniently released in situ by their thermal decomposition (e.g. LiZn₂(BH₄)₅, O. Friedrichs, A. Borgschulte, S. Cato, F. Buchter, R. Gremaud, A. Remhof, A. Züttel, Chemistry A European Journal, 15 (2009) 5531-5534). Various borohydrides can be used as precursors towards metal borides, prepared via thermal decomposition of borohydrides (e.g. Zr(BH₄)₄, Hf(BH₄)₄, derivatives of Ti(BH₄)₃, J. A. Jensen, J. E. Gozum, D. M. Pollina, G. S. Girolami, Journal of the American Chemical Society, 110 (1988) 1643-1644; U.S. Pat. No. 5,364,607; US 2011/0224085), or catalysts in polymerisation reactions (e.g. borohydride complexes of lanthanides tested as catalysts of ε-caprolactone polymerisation, A. Arbaoui, C. Redshaw, Polymer Chemistry, 1 (2010) 801-826; J. Thuilliez, C. Boisson, R. Spitz, US 2012/0142905 A1). Numerous borohydrides are widely used as reducing agents in various processes, e.g. organic synthesis or preparation of metal nanoparticles (NaBH₄, M. V. Nora de Souza, T. R. Alves Vasconcelos, Applied Organometallic Chemistry, 20 (2006) 798-810; H. S. Al-Ghamdi, W. E. Mahmoud, Materials Letters, 105 (2013) 62-64).

The main currently known methods of synthesis of mixed metal borohydrides of general formula MₓM′_{y}(BH₄) where M, M′ denote metal or complex cations (e.g. NH₄⁺, organic cations) and x, y, z denote stoichiometric coefficients are briefly described below.
(a) High-energy milling with use of a planetary or vibrational mill and a milling vessel of variable construction and material (e.g. containing balls or disc, made of stainless steel tungsten carbide, zirconium oxide, agate or other hard materials). A mixture of single cation borohydrides of general formula M(BH₄)ₘ and M′(BH₄), undergo chemical reaction according to the equation (1):

xM(BH₄)ₘ+yM′(BH₄)ₙ→MₓM′_{y}(BH₄)_{z} (1)
where M i M′ denote metal or complex cations (e.g. NH₄⁺, organic cations) of a charge of m and n, respectively, and z=xm+yn; c.f. L. Seballos, J. Z. Zhang, E. Ronnebro, J. L. Herberg, E. H. Majzoub, Journal of Alloys and Compounds, 476 (2009) 446-450; T. Jaroń, W. Grochala, Dalton Transactions, 40 (2011) 12808-12817.
(b) High-energy milling as in point (a) in which a metal halide, M′Xₙ, and a single metal borohydride, M(BH₄)ₘ, are used as precursors, according to the equation (2):

aM(BH₄)ₘ+bM′Xₙ→MₓM′_{y}(BH₄)_{z}+cM_{d}M′ₑX_{f} (2)
where M—metal cation of a charge m, M′ metal cation of a charge n; X—element from the 17^{th} group of periodic table of the elements, favourably Cl, F, a=z+cd, b=y+ce, n=cf, z=am; c.f. H. Hagemann, M. Longhini, J. W. Kaminski, T. A. Wesolowski, R. C\check{e}rný, N. Penin, M. H. Sørby, B. C. Hauback, G. Severa, C. M. Jensen, Journal of Physical Chemistry A, 112 (2008) 7551-7555, D. Ravnsbaek, Y. Filinchuk, Y. Cerenius, H. J. Jakobsen, F. Besenbacher, J. Skibsted, T. R. Jensen, Angewandte Chemie International Edition, 48 (2009) 6659-6663, F. E. Pinkerton, US 2012/0225008 A1.
(c) High-energy milling as in point (a) in which a metal halide, M′Xₙ, and a single metal borohydride, M(BH₄)ₘ, are used as precursors with addition of an aprotic solvent (tetrahydrofuran and diethyl ether have been applied); c.f. G. Xia, Q. Gia, Y. Guo, X. Yu, Journal of Materials Chemistry, 22 (2012) 7300-7307. A solvent can also be used for the extraction of the product of a mechanochemical reaction performed without solvent addition.
(d) Heating of the mixture of single metal borohydrides, as defined in point (a) with or without addition of solvent; c.f. W. I. F. David, M. Sommariva, P. P. Edwards, S. R. Johnson, M. Owen Jones, E. Anne Nickels, US 2012/0021311 A1. Also, mixed cation borohydrides containin aluminium, MₘAl(BH₄)ₙ, can be prepared via heating of Al(BH₄)₃ with low melting alkaline metal, like K, Rb, Cs, c.f. R. Zidan, R. F. Mohtadi, C. Fewox, P. Sivasubramanian, US 2012/0156118 A1.

The methods of synthesis of mixed cation borohydrides described above reveal serious drawbacks which seriously limit their applicability, e.g. low yield of reaction, synthesis of unexpected products, contamination of the synthesised borohydrides with by-products or precursors, c.f. H. Hagemann, R. \check{C}erny, Dalton Transactions, 39 (2010) 6006-6012.

Applicability of the methods (a) and (d) is limited by availability of the good quality precursors (i.e. pure single cation borohydrides), and their insufficient reactivity (c.f. T. Jaroń, W. Grochala, Dalton Transactions, 40 (2011) 12808-12817).

Synthesis according to the point (c) often leads to the solvated products from which solvent cannot be removed completely without decomposition of the mixed cation borohydride, c.f. T. Jaroń, W. Grochala, Dalton Transactions, 39 (2010) 160-166. The method (b) is the most frequently applied path of synthesis of mixed cation borohydrides for the research purposes. This method leads to the mixed metal borohydrides indelible contaminated with a halide by-product, MXₘ, content of which in the final product can exceed 50 wt %. Purification of such products with the use of various known methods is impossible. Moreover, the procedure described in the point (b) leads to the unexpected products like single metal borohydrides or mixed cation mixed anion borohydrides, i.e. the products with borohydride anions partially substituted with halide anions (c.f. T. Jaroń, W. Grochala, Dalton Transactions, 39 (2010) 160-166; D. B. Ravnsbk, M. B. Ley, Y.-S. Lee, H. Hagemann, V. D'Anna, Y. W. Cho, Y. Filinchuk, T. R. Jensen, International Journal of Hydrogen Energy, 37 (2012) 8428-8438).

The aim of the present invention is to provide efficient and convenient method of synthesis of unsolvated mixed cation borohydrides in a pure form, i.e. the compounds of general formula: MₓM′_{y}(BH₄) where M i M′ and x, y, z are as defined above. Another aim of the invention is to provide a method of synthesis in which chemical composition of the prepared compounds can be designed easily.

The present invention provides the method to achieve these aims.

### SUMMARY OF THE INVENTION

A method of synthesis of unsolvated mixed cation borohydrides having a general formula MₓM′_{y}(BH₄)_{z}, where M and M′ stand for metal cations, x, y and z are stoichiometric coefficients, according to the invention is characterized in that the precursors having a general formula M[An]ᵤ and [Cat]ᵥM′(BH₄)_{w} are used for the synthesis, where [An] stands for a weakly coordinating anion; [Cat] stands for a weakly coordinating cation; u, v and w are the stoichiometric coefficients; and the synthesis is carried out under an inert to the reagents atmosphere according to the general reaction equation:

xM[An]ᵤy[Cat]ᵥM′(BH₄)_{w}→MₓM′_{y}(BH₄)_{z}+xu[Cat][An] (3)

where z=yw, xu=yv; MₓM′_{y}(BH₄)_{z} is the product of the reaction; [Cat][An] is the by-product of the reaction which can be separated from the product using a properly selected solvent or a mixture of solvents, which neither dissolves, nor solvates the product MₓM′_{y}(BH₄)_{z}, while completely dissolves the by-product [Cat][An].

Preferably, precursors M[An]ᵤ contain weakly coordinating anions, [An], such as tetrakis(3,5-bis(trifluoro-methyl)phenyl)borate, tetrakis(perfluoro-tert-butoxy)aluminate, tetrakis(1,1,1,3,3,3-hexafluoro-2-phenyl-2-propoxy)aluminate, tetraphenylborate, tetrakis(pentafluoro-phenyl)borate, and their derivatives.

Preferably, precursors [Cat]ᵥM′(BH₄), contain weakly coordinated cations, [Cat], such as tetraalkylphosphonium, tetraarylphosphonium, tetraalkylammonium or tetraarylammonium, preferably tetrabuthylphosphonium, tetraoctylphosphonium, tetradodecylphosphonium, tetra-phenylphosphonium, tetrabuthylammonium, tetraoctylammonium, tetradodecylammonium, tetraphenylammonium cations.

Preferably, the product MₓM′_{y}(BH₄)_{z} is being separated from the by-product [Cat][An] by a complete dissolution of the by-product [Cat][An] in an anhydrous solvent or mixture of solvents which does not dissolve MₓM′_{y}(BH₄)_{z}, and does not form with MₓM′_{y}(BH₄)_{z} any stable solvates, preferably in dichloromethane, chloroform, perfluorodecaline, perfluorohexane or perfluorooctane.

Preferably, the product MₓM′_{y}(BH₄), is being separated from the by-product [Cat][An] by filtration or centrifugation of the unsoluble product MₓM′_{y}(BH₄)_{z}, and subsequent multiple wash of the product MₓM′_{y}(BH₄), with fresh portions of the same solvent.

Preferably, the product MₓM′_{y}(BH₄)_{z} is being separated from the by-product [Cat][An] using extractor, preferably Soxhlet extractor.

Preferably, the precursors M[An], contain metal cations M, preferably: Li⁺, Na⁺, K⁺, Rb⁺, Cs⁺, Be²⁺, Mg²⁺, Ca²⁺, Sr²⁺, Ba²⁺, Al³⁺, Ga³⁺, Y³⁺, La³⁺, Ce³⁺, Pr³⁺, Nd³⁺, Sm³⁺, Eu²⁺, Eu³⁺, Gd³⁺, Tb³⁺, Dy³⁺, Ho³⁺, Er³⁺, Tm³⁺, Yb²⁺, Yb³⁺, Lu³⁺, Cu⁺, Ag⁺, or complex cation NH₄⁺; and the precursors [Cat]ᵥM′(BH₄), contain metal cations M′, preferably: Be²⁺, Mg²⁺, Ca²⁺, Sr²⁺, Ba²⁺, Al³⁺, Ga³⁺, Sc³⁺, Y³⁺, La³⁺, Ce³⁺, Pr³⁺, Nd³⁺, Sm³⁺, Eu²⁺, Eu³⁺, Gd³⁺, Tb³⁺, Dy³⁺, Ho³⁺, Er³⁺, Tm³⁺, Yb²⁺, Yb³⁺, Lu³⁺, Ti³⁺, V²⁺, V³⁺, Mn²⁺, Fe³⁺, Co²⁺, Ni²⁺, Cu⁺, Zn²⁺, Cd²⁺.

Preferably, the reaction is carried out in the temperature ranging from −100° C. to +100° C., preferably in the temperature ranging from −40° C. to +40° C.

Preferably, the reaction is carried out under vacuum, in the atmosphere of hydrogen or in an inert atmosphere, preferably in the atmosphere of nitrogen, helium, neon, argon, krypton or xenon.

Preferably, the reaction is carried out in a liquid phase using solvent or mixture of solvents which neither dissolves MₓM′_{y}(BH₄)_{z}, nor forms with MₓM′_{y}(BH₄)_{z} any stable solvates, preferably using dichloromethane, chloroform, perfluorodecaline, perfluorohexane or perfluorooctane.

Alternatively, the reaction is carried out in a solid state without using of any solvents.

Preferably, the reaction in a solid phase is carried out using high energy rotational or vibrational mill with the milling vessel containing ball or disc milling elements, preferably made of stainless steel, tungsten carbide, or zirconium oxide.

Alternatively, the reaction in a solid phase is carried out by grinding in a mortar, preferably a ceramic or agate one.

Alternatively, the reaction is carried out using only a small amount of the solvent or the mixture of solvents which neither dissolves MₓM′_{y}(BH₄), nor forms with MₓM′_{y}(BH₄)_{z} any stable solvates, preferably using dichloromethane, chloroform, perfluorodecaline, perfluorohexane or perfluorooctane; and the volume of the solvent used is not higher than five times the volume of solid reagents used for the reaction.

Preferably, the reaction using only a small amount of the solvent or the mixture of solvents is carried out using high energy rotational or vibrational mill with milling vessel with ball or disc milling elements, preferably made of stainless steel, tungsten carbide, zirconium oxide.

Alternatively, the reaction using only a small amount of the solvent or the mixture of solvents is carried out by grinding in a mortar, preferably a ceramic or agate one.

The method of synthesis of unsolvated mixed cation borohydrides of general formula MₓM′_{y}(BH₄)_{z}, where M denotes a metal cation, preferably: Li⁺, Na⁺, Rb⁺, Cs+, Be²⁺, Mg²⁺, Ca²⁺, Sr²⁺, Ba²⁺, Al³⁺, Ga³⁺, Y³⁺, La³⁺, Ce³⁺, Pr³⁺, Nd³⁺, Sm³⁺, Eu²⁺, Eu³⁺, Gd³⁺, Tb³⁺, Dy³⁺, Ho³⁺, Er³⁺, Tm³⁺, Yb²⁺, Yb³⁺, Lu³⁺, Cu⁺, Ag⁺ or a complex cation, like NH₄⁺, while M′ denotes a metal cation, preferably: Be²⁺, Mg²⁺, Ca²⁺, Sr²⁺, Ba²⁺, Al³⁺, Ga³⁺, Sc³⁺, Y³⁺, La³⁺, Ce³⁺, Pr³⁺, Nd³⁺, Sm³⁺, Eu²⁺, Eu³⁺, Gd³⁺, Tb³⁺, Dy³⁺, Ho³⁺, Er³⁺, Tm³⁺, Yb²⁺, Yb³⁺, Lu³⁺, Ti³⁺, V²⁺, V³⁺, Mn²⁺, Fe³⁺, Co²⁺, Ni²⁺, Cu⁺, Zn²⁺, Cd²⁺, and x, y, z were defined above, has been explained in the examples contained below and illustrated in the drawing, where:

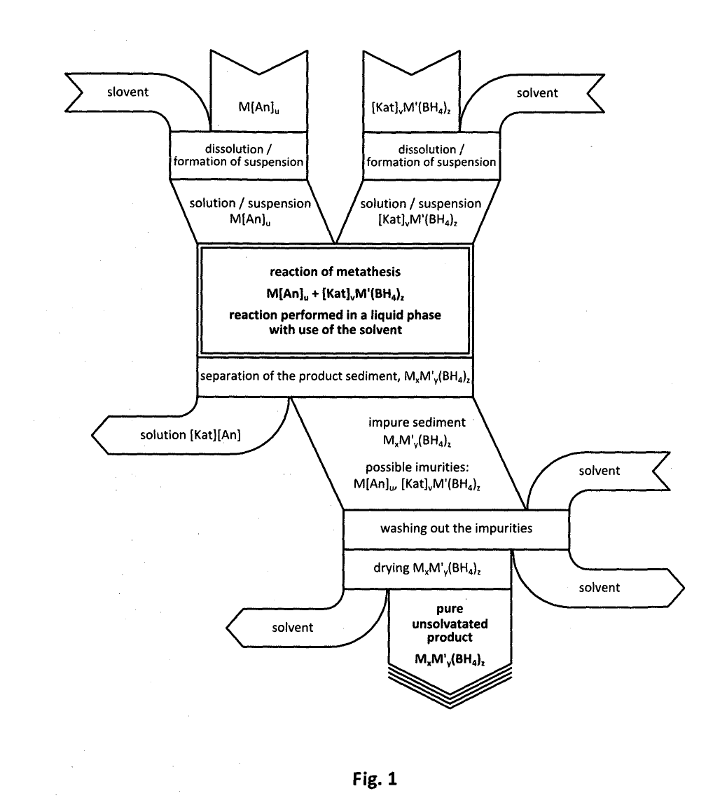

FIG. 1 shows a scheme of the synthesis of mixed cation borohydrides in liquid phase with the use of solvent,

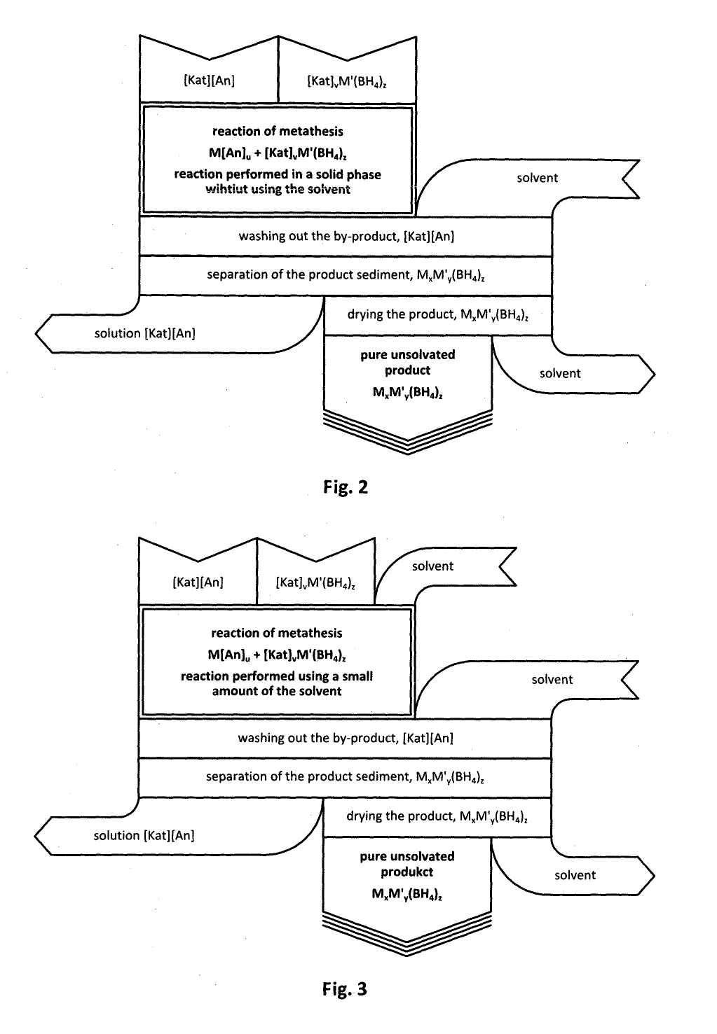

FIG. 2 shows a scheme of the synthesis of mixed cation borohydrides in solid state without the use of solvent,

FIG. 3 shows a scheme of the synthesis of mixed cation borohydrides with the use of small amount of solvent of the volume not exceeding the volume of the solid precursors by more than five times,

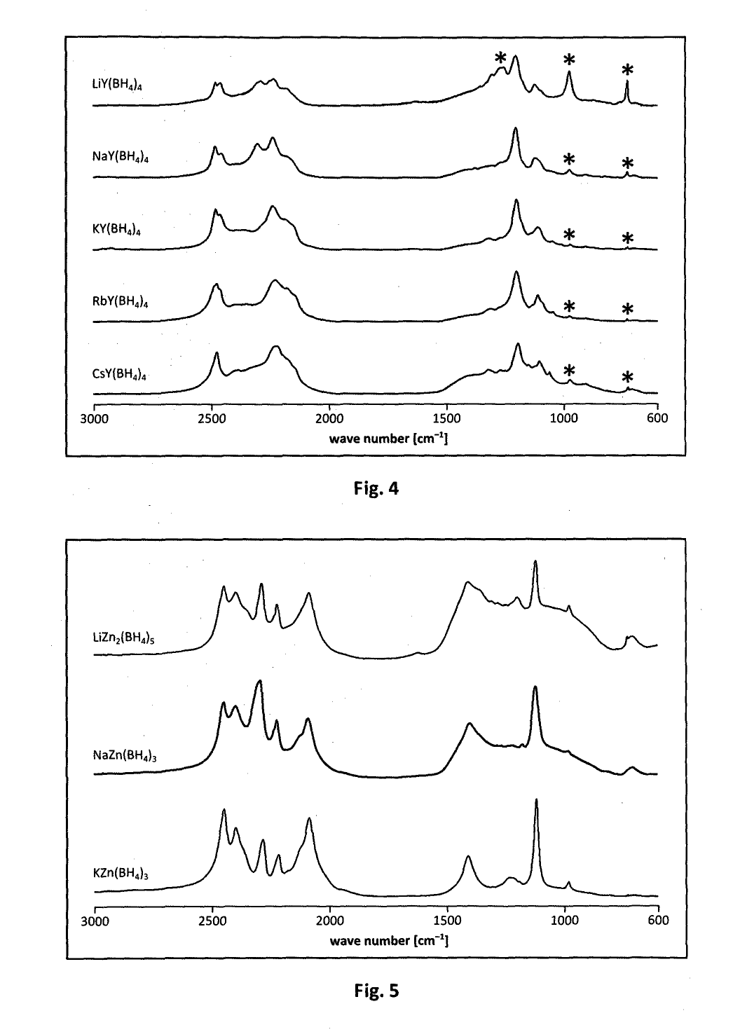

FIG. 4 shows the infrared absorption spectra of the mixed metal borohydrides containing alkali metal and yttrium, prepared according to the examples I-VII,

FIG. 5 shows the infrared absorption spectra of the mixed metal borohydrides containing alkali metal and zinc, prepared according to the examples VIII-X,

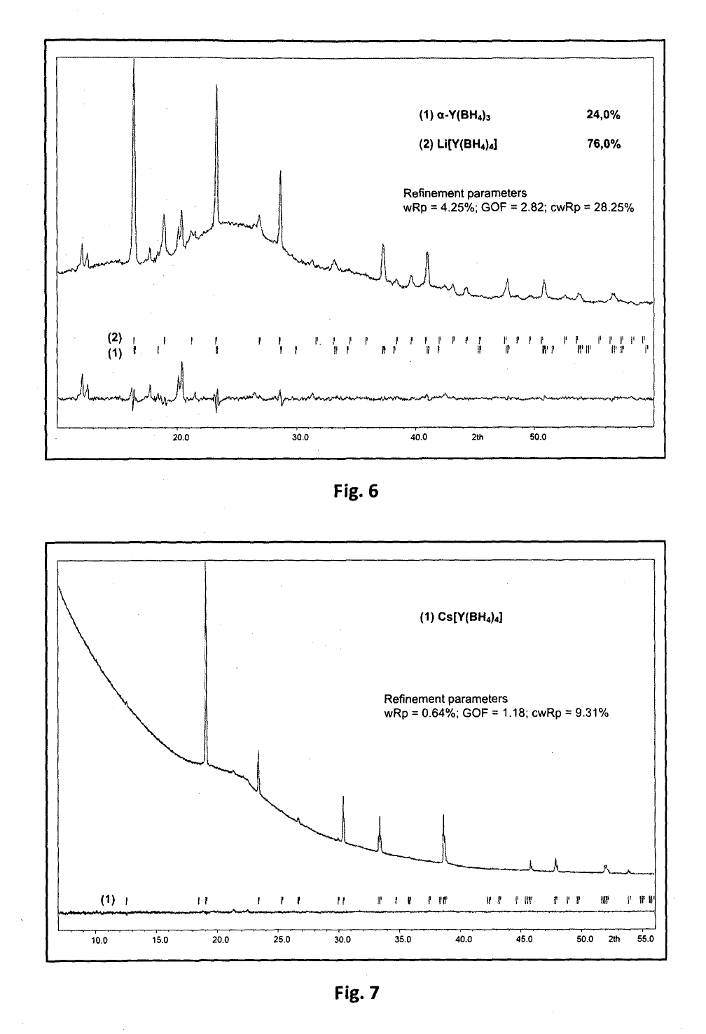

FIG. 6 shows powder X-ray diffraction (CoK_{α}) of the sample of LiY(BH₄)₄, prepared according to the example I,

FIG. 7 shows powder X-ray diffraction (CuK_{α}) of the sample of CsY(BH₄)₄, prepared according to the example VII,

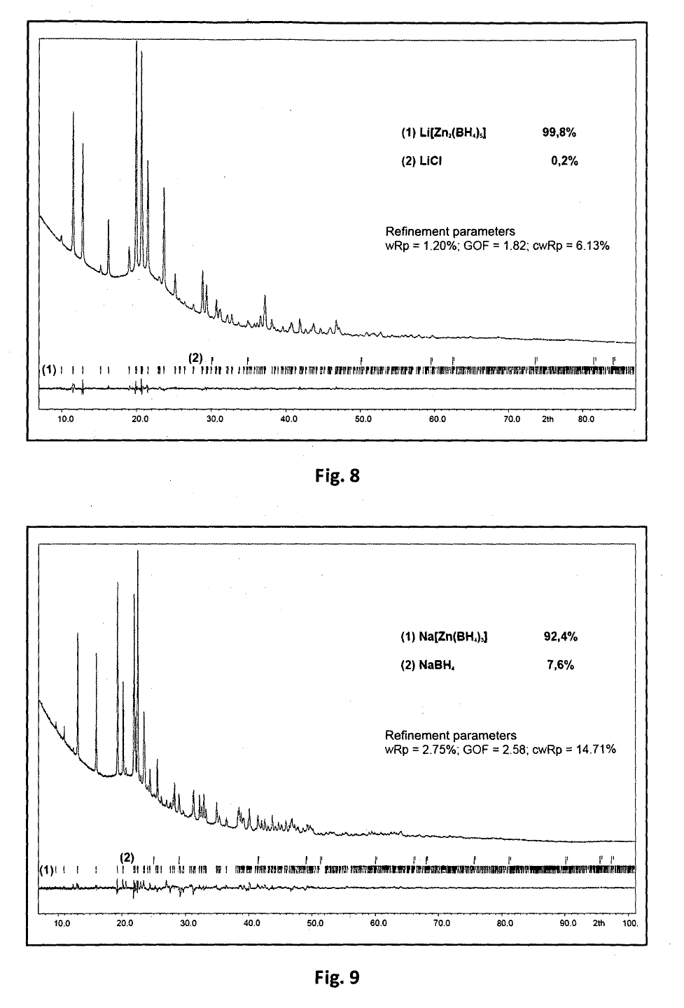

FIG. 8 shows powder X-ray diffraction (CuK_{α}) of the sample of LiZn₂(BH₄)₅, prepared according to the example VIII,

FIG. 9 shows powder X-ray diffraction (CuK_{α}) of the sample of NaZn(BH₄)₃, prepared according to the example IX.

### DETAILED DESCRIPTION OF THE INVENTION AND THE FIGURES OF DRAWING

According to the present invention the unsolvated mixed cation borohydrides of general formula MₓM′_{y}(BH₄)_{z}, with M, M′ and x, y and z as defined above, are synthesised in a metathesis reaction of general equation:

xM[An]ᵤ+y[Cat]ᵥM′(BH₄)_{w}→MₓM′_{y}(BH₄)_{z}+xu[Cat][An] (3)

where [An] and [Cat] denote weakly coordinating anion and weakly coordinated cation, respectively, which will be explained below, while u, v and w denote stoichiometric coefficients fulfilling the following conditions: z=yw, xu=yv. Reaction (3) can be conducted mechanochemically (in solid state) or in a solvent which neither dissolves MₓM′_{y}(BH₄)_{z}, nor forms with MₓM′_{y}(BH₄)_{z} any stable solvates, but dissolves completely the by-product [Cat][An]. The same solvent or a mixture of solvents is applied for the separation of the product of reaction (3) from the by-product, [Cat][An]. The solvent or the mixure of solvents includes the following solvents: dichloromethane, chloroform, perfluorodecalin, perfluorohexane, perfluorooctane.

One of the reactants of reaction (3), M[An]ᵤ, is a salt containing weakly coordinating anion, [An], and a metal or ammonium cation, denoted as M. The second one of the reactants of reaction (3), [Cat]ᵥM′(BH₄)_{w}, is a salt containing weakly coordinated cation, [Cat], and a complex anion [M′(BH₄)_{w}], containing metal cation, denoted as M′.

A weakly coordinating anion is defined as a single-charged anion with the charge distributed over several atoms and shielded sterically, which results in weak interactions with cations (S. H. Strauss, B. G. Nolan, T. J. Barbarich, J. J. Rockwell, U.S. Pat. No. 6,221,941 B1). The salts M[An]ᵤ containing the following anions, [An], are preferably used as reactants in reaction (3): tetrakis(3,5-bis(trifluoromethyl)phenyl)borate—[B(C₆H₃(CF₃)₂)₄]⁻, tetrakis(perfluoro-tert-butoxy)aluminate—[Al(OC(CF₃)₃)₄]⁻, tetrakis(1,1,1,3,3,3-hexafluoro-2-phenyl-2-propoxy)aluminate—[Al(OC(CF₃)₂(C₆H₅))₄]⁻, tetraphenylborate—[B(C₆H₅)₄]⁻, tetrakis(pentafluorophenyl)borate—[B(C₆F₅)₄]⁻, and their derivatives. Many of the above mentioned M[An]ᵤ reactants are commercially available and are applied in science and technology, e.g. in gravimetric analysis, ion selective electrodes. These compounds can be easily prepared in pure form in simple, one or two stage reactions starting from the easily available precursors, e.g. in reaction of tetrafluoroborates with Grignard reagents or in reaction of alanates with corresponding alcohols.

A weakly coordinated cation is defined as a single-charged cation with the charge shielded sterically, which results in weak interactions with anions. The salts [Cat]ᵥM′(BH₄)_{w} containing the following anions, [Cat], are used as reactants in reaction (3): tetraalkylphosphonium, tetraarylphosphonium, tetraalkylammonium or tetraarylammonium, preferably tetrabuthylphosphonium, tetraoctylphosphonium, tetradodecylphosphonium, tetraphenyiphosphonium, tetrabuthylammonium, tetraoctylammonium, tetradodecylammonium, tetraphenylammonium. The [Cat]ᵥM′(BH₄)_{w} salts are selected individually for the specified metal M′. While the [Cat]ᵥM′(BH₄)_{w} salts are not available commercially, they can be easily prepared according to the number of reactions, which for instance can be performed mechanochemically via grinding or milling of the reactants:

M′(BH₄)_{w-v}+v[Cat]BH₄→[Cat]ᵥM′(BH₄)_{w} (4)

M′X_{w-v}+(w-v)LiBH₄[Cat]BH₄→[Cat]ᵥM′(BH₄)_{w}+(w-v)LiX (5)

M′X_{w-v}+wLiBH₄+v[Cat]X→[Cat]ᵥM′(BH₄)_{w}+wLiX (6)

where X denotes a halide, preferably CI, and the other symbols are as defined above. LiBH₄ can often be replaced with other available borohydrides, preferably NaBH₄. Reaction (4) leads to a pure [Cat]ᵥM′(BH₄)_{w} precursor, while the products of reactions (5) and (6) are separated from LiX by-product via a solvent extraction, e.g. using Soxhlet extractor, with the use of solvent which does not form stable solvates with the product, e.g. dichloromethane, chloroform, perfluorodecalin. The solution from the extraction process can be used directly for conducting of reaction (3). An example of synthesis of [Cat]ᵥM′(BH₄)_{w} precursor according to equation (4) has been described in the publication: T. Jaroń, W. Wegner, M. K. Cyrański, [symbol] . Dobrzycki, W. Grochala, Journal of Solid State Chemistry, 191 (2012) 279-282, where [(C₄H₉)₄N]Y(BH₄)₄, with [Cat]=[(C₄H₉)₄N], M′=Y, v=1, w=4 has been described. The synthesis of [Cat]ᵥM′(BH₄)_{w} according to the equations (5) and (6) can be performed in similar manner.

To perform reaction (3) using a solvent or a mixture of solvents, which does not dissolve and does not form stable solvates with the MₓM′_{y}(BH₄)_{z} product, the solutions of M[An]ᵤ and [Cat]ᵥM′(BH₄)_{w} are mixed together. The product, MₓM′_{y}(BH₄)_{z}, precipitates, while the by-product of reaction (3), [Cat][An], remains dissolved. The precipitated MₓM′_{y}(BH₄)_{w} product is then separated from the post-reaction solution, preferably using the filtration or centrifugation, and is washed several times with fresh portions of the solvent used for reaction. The synthesis can be performed in a broad range of temperatures, preferably between 20° C. and 30° C. However, the synthesis of the thermally unstable products requires significantly lower temperatures, preferably 40° C. or below.

To perform reaction (3) in a solid phase without a solvent, M[An]ᵤ and [Cat]ᵥM′(BH₄)_{w} are ground or milled together under the atmosphere of an inert gas. The post-reaction mixture contains the product, MₓM′_{y}(BH₄)_{z}, and the by-product of reaction (3), [Cat][An]. The [Cat][An] by-product is then separated from the reaction product, MₓM′_{y}(BH₄)_{z}, using solvent extraction, with the solvent or a mixture of solvents, which neither dissolves MₓM′_{y}(BH₄)_{z}, nor forms with MₓM′_{y}(BH₄)_{z} any stable solvates. The synthesis and purification of the product can be performed in a broad range of temperatures, preferably between 20° C. and 30° C. However, the synthesis of the thermally unstable products requires significantly lower temperatures, preferably −40° C. or below.

To perform reaction (3) using only a small portion of solvent of the volume not higher than five times the volume of solid reagents used for the reaction, M[An]ᵤ and [Cat]ᵥM′(BH₄)_{w} are moisten with a small amount of solvent or a mixture of solvents which neither dissolves MₓM′_{y}(BH₄)_{z}, nor forms with MₓM′_{y}(BH₄)_{z} any stable solvate, and are ground or milled together under the atmosphere of an inert gas. The post-reaction mixture contains the product, MₓM′_{y}(BH₄)_{z}, and the by-product of reaction (3), [Cat][An]. The [Cat][An] by-product is then separated from the reaction product, MₓM′_{y}(BH₄)_{z}, using solvent extraction, with the same solvent or the mixture of solvents, which does not dissolve and does not form stable solvates with the MₓM′_{y}(BH₄)_{z} product. The synthesis and purification of the product can be performed in a broad range of temperatures, preferably between 20° C. and 30° C. However, the synthesis of the thermally unstable products requires significantly lower temperatures, preferably 40° C. or below.

Reaction (3) may lead also to single cation borohydride, M(BH₄)ₙ, when M=M′, i.e. if M[An]ᵤ and [Cat]ᵥM(BH₄)_{w} reactants are used. This method allows for synthesis of the single cation borohydrides which cannot be prepared in a pure form according to other methods (e.g. Y(BH₄)₃ contaminated by ca. 50 wt % of LiCl has been synthesised, c.f. T. Jaroń, W. Grochala, Dalton Transactions, 39 (2010) 160-166).

All the above mentioned reactions should be performed in moisture-free equipment, under inert atmosphere, preferably in nitrogen, helium, neon, argon, krypton, xenon. It is possible to perform the synthesis under hydrogen atmosphere, which is neutral for borohydrides. For the products which do not decompose with the evolution of gas below 40° C. the synthesis under vacuum is also possible.

The solvent used in reaction (3) can be recovered in the course of separating the same form the reaction by-product by the means of distillation or reverse osmosis.

### DETAILED DESCRIPTION OF THE DRAWING

The scheme of the method of synthesis according to the invention has been presented in FIGS. 1-3. The examples of the spectroscopic and diffraction analysis of the synthesised products have been presented in FIGS. 4-9.

FIG. 1 shows a scheme of the synthesis of mixed cation borohydrides in liquid phase with the use of solvent. In the first stage the solutions of the M[An]ᵤ and [Cat]ᵥM′(BH₄)_{w} reactants are mixed under the inert atmosphere. Subsequently, the solution containing [Cat][An] by-product is separated from the precipitated MₓM′_{y}(BH₄)_{z} product of reaction (3) via filtration.

FIG. 2 shows a scheme of the synthesis of mixed cation borohydrides in solid state without the use of solvent. In the first stage the mixture of the M[An]ᵤ and [Cat]ᵥM′(BH₄)_{w} reactants is ground or milled under the inert atmosphere. Subsequently, the [Cat][An] by-product is separated from the MₓM′_{y}(BH₄), product of reaction (3) via solvent extraction.

FIG. 3 shows a scheme of the synthesis of mixed cation borohydrides using only a small portion of solvent of the volume not higher than five times the volume of solid reagents used for the reaction. In the first stage the mixture of the M[An]ᵤ and [Cat]ᵥM′(BH₄)_{w} reactants moisten with a small amount of solvent is ground or milled under the inert atmosphere. Subsequently, the [Cat][An] by-product is separated from the MₓM′_{y}(BH₄), product of reaction (3) via solvent extraction.

FIG. 4 shows the infrared absorption spectra of the yttrium-containing mixed cation borohydrides: LiY(BH₄)₄, NaY(BH₄)₄, KY(BH₄)₄, RbY(BH₄)₄, CsY(BH₄)₄, which have been prepared according to the examples I-VII. The signals contributed by the identified impurities, related to the used precursors, have been marked with asterisks.

FIG. 5 shows the infrared absorption spectra of the zinc-containing mixed cation borohydrides: LiZn(BH₄)₅, NaZn(BH₄)₃, KZn(BH₄)₃, prepared according to the examples VIII-X.

FIG. 6 shows the powder X-ray diffraction analysis (CoK_{α}) for the sample of LiY(BH₄)₄ prepared according to the example I: the experimental curve (top), the difference curve showing discreancy between the experimental and calculated curves, as calculated using Rietveld method (bottom).

FIG. 7 shows the powder X-ray diffraction analysis (CuK_{α}) for the sample of CsY(BH₄)₄ prepared according to the example VII: the experimental curve (top), the difference curve showing discreancy between the experimental and calculated curves, as calculated using Rietveld method (bottom).

FIG. 8 shows the powder X-ray diffraction analysis (CuK_{α}) for the sample of LiZn₂(BH₄)₅ prepared according to the example VIII: the experimental curve (top), the difference curve showing discreancy between the experimental and calculated curves, as calculated using Rietveld method (bottom).

FIG. 9 shows the powder X-ray diffraction analysis (CuK_{α}) for the sample of NaZn(BH₄)₃ prepared according to the example IX: the experimental curve (top), the difference curve showing discreancy between the experimental and calculated curves, as calculated using Rietveld method (bottom).

### EXAMPLES

A method of synthesis of unsolvated mixed cation borohydrides of a general formula MₓM′_{y}(BH₄), performed according to the equation (3) has been further explained in the following examples.

### Example I

Synthesis of LiY(BH₄)₄ performed in solution. To the suspension of 0.97 g of Li[Al(OC(CF₃)₃)₄] (1 mmol) in 80 ml cold (−35° C.) anhydrous dichloromethane the cold (−35° C.) solution of 0.41 g of [(C₄H₉)₄N]Y(BH₄)₄ (1.05 mmol, 5% excess) in 10 ml of dichloromethane was added and stirred for 30 min. at ca. 35° C. The LiY(BH₄)₄ precipitate was filtered off using a funnel with a dense glass frit and washed four times with a small amount of cold (−35° C.) dichloromethane (ca. 5 ml). The washed LiY(BH₄)₄ was subsequently dried under vacuum at ca. −35° C. The product, as an unstable compound, requires storage below −35° C. The purity of the obtained LiY(BH₄)₄ was evaluated by powder X-ray diffraction and infrared absorption spectroscopy (FIG. 4). On the basis of these results the crystal structure of LiY(BH₄)₄ has been solved (number in the ICSD database of the crystal structures: 427326) and the purity of the product has been determined as exceeding 75% (FIG. 6). The low purity of the product is due to its thermal instability. All the manipulations were done under dry inert gas (Ar) atmosphere.

### Example II

Synthesis of NaY(BH₄)₄ performed in solution. To the suspension of 0.886 g of Na[B(C₆H₃(CF₃)₂)₄] (1 mmol) in 100 ml anhydrous dichloromethane the solution of 0.41 g of [(C₄H₉)₄N]Y(BH₄)₄ (1.05 mmol, 5% excess) in 10 ml of dichloromethane was added and stirred for 30 min. at room temperature (ca. 25° C.). The NaY(BH₄)₄ precipitate was filtered off using a funnel with a dense glass frit and washed four times with a small amount of dichloromethane (ca. 5 ml). The washed NaY(BH₄)₄ was subsequently dried under vacuum at room temperature. The purity of the obtained NaY(BH₄)₄ was evaluated by powder X-ray diffraction and infrared absorption spectroscopy (FIG. 4). On the basis of these results the crystal structure of NaY(BH₄)₄ has been solved (number in the ICSD database of the crystal structures: 427325) and the purity of the product has been determined as exceeding 95%. All the manipulations were done under dry inert gas (Ar) atmosphere.

### Example III

Synthesis of KY(BH₄)₄ performed in solution. To the suspension of 1.01 g of K[Al(OC(CF₃)₃)₄] (1 mmol) in 40 ml anhydrous dichloromethane the solution of 0.41 g of [(C₄H₉)₄N]Y(BH₄)₄ (1.05 mmol, 5% excess) in 10 ml of dichloromethane was added and stirred for 30 min. at room temperature (ca. 25° C.). The KY(BH₄)₄ precipitate was filtered off using a funnel with a dense glass frit and washed four times with a small amount of dichloromethane (ca. 5 ml). The washed KY(BH₄)₄ was subsequently dried under vacuum at room temperature. The purity of the obtained KY(BH₄)₄ was evaluated by powder X-ray diffraction and infrared absorption spectroscopy (FIG. 4). On the basis of these results the purity of the product has been determined as exceeding 95%. All the manipulations were done under dry inert gas (Ar) atmosphere.

### Example IV

Synthesis of KY(BH₄)₄ performed in solid state, without using of any solvent. 1.01 g of K[Al(OC(CF₃)₃)₄] (1 mmol) and 0.41 g of [(C₄H₉)₄N]Y(BH₄)₄ (1.05 mmol, 5% excess) were mixed and milled for 15 min. in the milling vessel made of stainless steel with a disc used as the milling element. The process has been carried out at room temperature (ca. 25° C.). The mixture of KY(BH₄)₄ and [(C₄H₉)₄N][Al(OC(CF₃)₃)₄] was extracted with anhydrous dichloromethane for ca. 2 h using a Soxhlet extractor. The purified KY(BH₄)₄ was subsequently dried under vacuum at room temperature. The purity of the obtained KY(BH₄)₄ was evaluated by powder X-ray diffraction and infrared absorption spectroscopy (FIG. 4). On the basis of these results the purity of the product has been determined as exceeding 95%. All the manipulations were done under dry inert gas (Ar) atmosphere.

### Example V

Synthesis of KY(BH₄)₄ performed using a small amount of solvent. 1.01 g of K[Al(OC(CF₃)₃)₄] (1 mmol) and 0.41 g of [(C₄H₉)₄N]Y(BH₄)₄ (1.05 mmol, 5% excess) were mixed, moisten with ca. 1 ml of anhydrous dichloromethane and milled for 15 min. in the milling vessel made of stainless steel with a disc used as the milling element. The process has been carried out at room temperature (ca. 25° C.). The mixture of KY(BH₄)₄ and [(C₄H₉)₄N][Al(OC(CF₃)₃)₄] was extracted with anhydrous dichloromethane for ca. 2 h using a Soxhlet extractor. The purified KY(BH₄)₄ was subsequently dried under vacuum at room temperature. The purity of the obtained KY(BH₄)₄ was evaluated by powder X-ray diffraction and infrared absorption spectroscopy (FIG. 4). On the basis of these results the purity of the product has been determined as exceeding 95%. All the manipulations were done under dry inert gas (Ar) atmosphere.

### Example VI

Synthesis of RbY(BH₄)₄ performed in solution. To the suspension of 1.05 g of Rb[Al(OC(CF₃)₃)₄] (1 mmol) in 40 ml anhydrous dichloromethane the solution of 0.41 g of [(C₄H₉)₄N]Y(BH₄)₄ (1.05 mmol, 5% excess) in 10 ml of dichloromethane was added and stirred for 30 min. at room temperature (ca. 25° C.). The RbY(BH₄)₄ precipitate was filtered off using a funnel with a dense glass frit and washed four times with a small amount of dichloromethane (ca. 5 ml). The washed RbY(BH₄)₄ was subsequently dried under vacuum at room temperature. The purity of the obtained RbY(BH₄)₄ was evaluated by powder X-ray diffraction and infrared absorption spectroscopy (FIG. 4). On the basis of these results the purity of the product has been determined as exceeding 95%. All the manipulations were done under dry inert gas (Ar) atmosphere.

Example VII. Synthesis of CsbY(BH₄)₄ performed in solution. To the suspension of 1.10 g of Cs[Al(OC(CF₃)₃)₄] (1 mmol) in 40 ml anhydrous dichloromethane the solution of 0.41 g of [(C₄H₉)₄N]Y(BH₄)₄ (1.05 mmol, 5% excess) in 10 ml of dichloromethane was added and stirred for 30 min. at room temperature (ca. 25° C.). The CsY(BH₄)₄ precipitate was filtered off using a funnel with a dense glass frit and washed four times with a small amount of dichloromethane (ca. 5 ml). The washed CsY(BH₄)₄ was subsequently dried under vacuum at room temperature. The purity of the obtained CsY(BH₄)₄ was evaluated by powder X-ray diffraction and infrared absorption spectroscopy (FIG. 4). On the basis of these results the purity of the product has been determined as close to 100%. All the manipulations were done under dry inert gas (Ar) atmosphere.

### Example VIII

Synthesis of LiZn₂(BH₄)₅ performed in solution. To the suspension of 0.97 g of Li[Al(OC(CF₃)₃)₄] (1 mmol) in 40 ml anhydrous dichloromethane the solution of 0.57 g of [(C₆H₅)₄P]Zn₂(BH₄)₅ (1.05 mmol, 5% excess) in 10 ml of dichloromethane was added and stirred for 30 min. at room temperature (ca. 25° C.). The LiZn₂(BH₄)₅ precipitate was filtered off using a funnel with a dense glass frit and washed four times with a small amount of dichloromethane (ca. 5 ml). The washed LiZn₂(BH₄)₅ was subsequently dried under vacuum at room temperature. The purity of the obtained LiZn₂(BH₄)₅ was evaluated by powder X-ray diffraction and infrared absorption spectroscopy (FIG. 5). On the basis of these results the purity of the product has been determined as 99.8% (FIG. 8). All the manipulations were done under dry inert gas (Ar) atmosphere.

### Example IX

Synthesis of NaZn(BH₄)₃ performed in solution. To the suspension of 0.886 g of Na[B(C₆H₃(CF₃)₂)₄] (1 mmol) in 40 ml anhydrous dichloromethane the solution of 0.37 g of [(n-C₄H₉)₄N]Zn(BH₄)₃ (1.05 mmol, 5% excess) in 10 ml of dichloromethane was added and stirred for 30 min. at room temperature (ca. 25° C.). The NaZn(BH₄)₃ precipitate was filtered off using a funnel with a dense glass frit and washed four times with a small amount of dichloromethane (ca. 5 ml). The washed NaZn(BH₄)₃ was subsequently dried under vacuum at room temperature. The purity of the obtained NaZn(BH₄)₃ was evaluated by powder X-ray diffraction and infrared absorption spectroscopy (FIG. 5). On the basis of these results the purity of the product has been determined as 92.4% (FIG. 9). All the manipulations were done under dry inert gas (Ar) atmosphere.

### Example X

Synthesis of KZn(BH₄)₃ performed in solution. To the suspension of 1.01 g of K[Al(OC(CF₃)₃)₄] (1 mmol) in 100 ml anhydrous dichloromethane the solution of 0.37 g of [(n-C₄H₉)₄N]Zn(BH₄)₃ (1.05 mmol, 5% excess) in 10 ml of dichloromethane was added and stirred for 30 min. at room temperature (ca. 25° C.). The KZn(BH₄)₃ precipitate was filtered off using a funnel with a dense glass frit and washed four times with a small amount of dichloromethane (ca. 5 ml). The washed KZn(BH₄)₃ was subsequently dried under vacuum at room temperature. The purity of the obtained KZn(BH₄)₃ was evaluated by powder X-ray diffraction and infrared absorption spectroscopy (FIG. 5). On the basis of these results the purity of the product has been determined as 93.6%. All the manipulations were done under dry inert gas (Ar) atmosphere.

1. A method of synthesis of unsolvated mixed cation borohydrides having a general formula MₓM′_{y}(BH₄)₂, where M and M′ stand for metal cations, x, y and z are stoichiometric coefficients, characterized in that the precursors having a general formula M[An]ᵤ and [Cat]ᵥM′(BH₄)_{w} are used for the synthesis, where [An] stands for a weakly coordinating anion; [Cat] stands for weakly coordinating cation; u, v and w are the stoichiometric coefficients; and the synthesis is carried out under an inert to the reagents atmosphere according to the general reaction equation:
xM[Ah]ᵤ+y[Cat]ᵥM′(BH₄)_{w}→MₓM′_{y}(BH₄)_{z}+xu[Cat][An]
where z=yw, xu=yv; MₓM′_{y}(BH₄)_{z} is the product of the reaction; [Cat][An] is the by-product of the reaction which can be separated from the product using a properly selected solvent or a mixture of solvents, which neither dissolves, nor solvates the product MₓM′_{y}(BH₄)_{z}, while completely dissolves the by-product [Cat][An].

2. The method of claim 1, characterized in that the precursors M[An]ᵤ contain weakly coordinating anions, [An], such as tetrakis(3,5-bis(trifluoro-methyl)phenyl)borate, tetrakis(perfluoro-tert-butoxy)aluminate, tetrakis(1,1,1,3,3,3-hexafluoro-2-phenyl-2-propoxy)aluminate, tetraphenylborate, tetrakis(pentafluoro-phenyl)borate, and their derivatives.

3. The method of claim 1, characterized in that the precursors [Cat]ᵥM′(BH₄)_{w} contain weakly coordinated cations, [Cat], such as tetraalkylphosphonium, tetraarylphosphonium, tetraalkylammonium or tetraarylammonium, preferably tetrabuthylphosphonium, tetraoctylphosphonium, tetradodecylphosphonium, tetra-phenylphosphonium, tetrabuthylammonium, tetraoctylammonium, tetradodecylammonium, tetraphenylammonium cations.

4. The method of claim 1, characterized in that the product MₓM′_{y}(BH₄)_{z} is being separated from the by-product [Cat][An] by a complete dissolution of the by-product [Cat][An] in an anhydrous solvent or mixture of solvents which does not dissolve MₓM′_{y}(BH₄)_{z}, and does not form with MₓM′_{y}(BH₄)_{z} any stable solvates, preferably in dichloromethane, chloroform, perfluorodecaline, perfluorohexane or perfluorooctane.

5. The method of claim 4, characterized in that the product MₓM′_{y}(BH₄), is being separated from the by-product [Cat][An] by filtration or centrifugation of the unsoluble product MₓM′_{y}(BH₄)_{z}, and subsequent multiple wash of the product MₓM′_{y}(BH₄)_{z} with fresh portions of the same solvent.

6. The method of claim 4, characterized in that the product MₓM′_{y}(BH₄)_{z} is being separated from the by-product [Cat][An] using extractor, preferably Soxhlet extractor.

7. The method of claim 1, characterized in that the precursors M[An]ᵤ contain metal cations M, preferably: Li⁺, Na⁺, K⁺, Rb⁺, Cs⁺, Be²⁺, Mg²⁺, Ca²⁺, Sr²⁺, Ba²⁺, Ga³⁺, Y³⁺, La³⁺, Ce³⁺, Pr³⁺, Nd³⁺, Sm³⁺, Eu²⁺, Eu³⁺, Gd³⁺, Tb³⁺, Dy³⁺, Ho³⁺, Er³⁺, Tm³⁺, Yb²⁺, Yb³⁺, Lu³⁺, Cu⁺, Ag⁺, or complex cation NH₄⁺; and the precursors [Cat]ᵥM′(BH₄)_{z} contain metal cations M′, preferably: Be²⁺, Mg²⁺, Ca²⁺, Sr²⁺, Ba²⁺, Al³⁺, Ga³⁺, Sc³⁺, Y³⁺, La³⁺, Ce³⁺, Pr³⁺, Nd³⁺, Sm³⁺, Eu²⁺, Eu³⁺, Gd³⁺, Tb³⁺, Dy³⁺, Ho³⁺, Er³⁺, Tm³⁺, Yb²⁺, Yb³⁺, Lu³⁺, Ti³⁺, V²⁺, V³⁺, Mn²⁺, Fe³⁺, Co²⁺, Ni²⁺, Cu⁺, Zn²⁺, Cd²⁺.

8. The method of claim 1, characterized in that the reaction is carried out in the temperature ranging from −100° C. to +100° C., preferably in the temperature ranging from −40° C. to +40° C.

9. The method of claim 1, characterized in that the reaction is carried out under vacuum, in the atmosphere of hydrogen or in an inert atmosphere, preferably in the atmosphere of nitrogen, helium, neon, argon, krypton or xenon.

10. The method of any one of the preceding claims 1-9, characterized in that the reaction is carried out in a liquid phase using solvent or mixture of solvents which neither dissolves MₓM′_{y}(BH₄)_{z}, nor forms with MₓM′_{y}(BH₄)_{z} any stable solvates, preferably using dichloromethane, chloroform, perfluorodecaline, perfluorohexane or perfluorooctane.

11. The method of any one of the preceding claims 1-9, characterized in that the reaction is carried out in a solid state without using of any solvents.

12. The method of claim 11, characterized in that the reaction is carried out using high energy rotational or vibrational mill with the milling vessel containing ball or disc milling elements, preferably made of stainless steel, tungsten carbide, zirconium oxide.

13. The method of claim 11, characterized in that the reaction is carried out by grinding in a mortar, preferably a ceramic or agate one.

14. The method of any one of the preceding claims 1-9, characterized in that the reaction is carried out using only a small amount of the solvent or the mixture of solvents which neither dissolves MₓM′_{y}(BH₄)_{z} nor forms with MₓM′_{y}(BH₄)_{z} any stable solvates, preferably using dichloromethane, chloroform, perfluorodecaline, perfluorohexane or perfluorooctane; and the volume of the solvent used is not higher than five times the volume of solid reagents used for the reaction.

15. The method of claim 14, characterized in that the reaction is carried out using high energy rotational or vibrational mill with milling vessel with ball or disc milling elements, preferably made of stainless steel, tungsten carbide, zirconium oxide.

16. The method of claim 14, characterized in that the reaction is carried out by grinding in a mortar, preferably a ceramic or agate one.
